(19) United States
(12) Patent Application Publication
(10) Pub. No.: US 2005/0278929 A1
(43) Pub. Date: Dec. 22, 2005

(54) Process of manufacturing stent with therapeutic function in the human body

(75) Inventor: Wun-Hsing Lee, Taipei City (TW)

Correspondence Address: APEX JURIS, PLLC, 13194 EDGEWATER LANE NORTHEAST, SEATTLE, WA, 98125, US

(73) Assignee: National Taipei University Technology, Taipei City (TW)

(21) Appl. No.: 10/869,135

(22) Filed: Jun. 16, 2004

(51) Int. Cl. B23P 25/00

(52) U.S. Cl. 29/458; 29/558

(57) ABSTRACT

The present invention provides a method for fabricating an implant stent with therapeutic effects. The method of the present invention includes designing and delineating a pattern of the implant stent, drilling a thin metal sheet to form positioning holes, cutting a desired pattern on the thin metal sheet according to the designed pattern, drilling a hole on a line rib of the stent to form a braided structure by a micro discharge processor according to the desired pattern. Then, the stent is cleaned and polished by the electropolish to trim the edge and the rough surface of the stent. Then, the biodegradable material, PLLA, PGA, fibrinogen, the polyurethane-polyethylene oxide mixed with the heparin or the combination thereof, is used for forming the mixed material with the high molecular weight, and is solved in a solvent, wherein another grinded therapeutic drug with the micro or the nano size is added. The drug can be As₂O₅, an anti-caner drug, or an anti-inflammation drug. The solution with the bioadsordable material having a therapeutic drug is atomized and sprayed on the outer and inner surfaces of the stent. Since a row of holes are arranged on the line rib of the stent, each hole is immersed into the solution due to the capillary phenomenon. When the solution is completely evaporated, the biodegradable and absordable material and the drug are coagulated to form a solid and to strongly coat on the surface of the stent. When the stent is implanted into a human body, the solid layer is slowly degraded and released on the injured site, so that the vessel is prevented from restenosis, and the therapeutic effect is achieved. The stent can be fabricated by the precision machine technology in Taiwan, so that the implant stent with low cost and therapeutic effects is obtained.

### FIELD OF THE INVENTION

The object of the present invention is to provide a method for fabricating an implant stent with therapeutic effects. The so-called stent has a braided tubing structure for being implanted into all tubing tissues, such as vessels, cystic ducts, ureters, vas deferens or oviducts in a human body, so that the blocked portions of the tubing tissues are expanded. In accordance with the present invention, the method for fabricating an implant stent includes designing and delineating the pattern of the implant stent, drilling a thin metal sheet for positioning, cutting a braided pattern of the stent according to the designed pattern, and drilling a hole on a line rib by a micro discharge processor, so that the semi-manufactured stent is a metal braided sheet with a row of holes on each line rib i.e. a planar vessel stent. Then, the planar stent is rolled and soldered by micro-soldering to form a metal braided stent, and furthermore the stent is cleaned and polished by electropolish to trim the burr and the rough surface. Then, the biodegradable and absordable material is solved in associated solution, wherein a therapeutic drug powder with micro/nano size is added, and the therapeutic drug is the anticancer drug or the antiphlogistic. The solution with the bioadsordable material having a therapeutic drug is atomized and sprayed on the outer and inner surfaces of the stent. Since a row of holes are arranged on the line rib of the stent, each hole is immersed into the solution due to the capillary phenomenon. When the solution is completely evaporated, the biodegradable and absordable material and the drug are coagulated to form a solid and to strongly coat on the surface of the stent. When the stent is implanted into a human body, the solid layer is slowly degraded and released on the injured site, so that the vessel is prevented from restenosis, and the therapeutic effect is achieved. The stent can be fabricated by the precision machine technology in Taiwan, so that the implant stent with low cost and therapeutic effects is obtained.

### DESCRIPTION OF THE PRIOR ART

Recently, the cardiovascular disease is a major lethal disease in most industrialized countries. In which, the atherosclerosis is a condition caused by a build-up of plaque in the inner lining of an artery. For treating atherosclerosis, it is effective to directly implant a stent in the blocked portion of the artery. In addition, nowadays many people suffer from plaques in ascystic ducts, ureters, vas deferens or oviducts, and the late-stage cancer patient have plaques in intraluminal owing to abnormal proliferated cancer cells. These diseases can be treated by the stent, and furthermore plural stents are implanted in a human body. Therefore, the stent is wildly applied and needed.

For implanting the vascular stent, the vascular stent is placed on the blocked portion in a vessel. Since the stent has elasticity, the vessel is expanded by the stent, and blood can flow through the vessel. There are two ways to place the stent in a blocked vessel. One includes the step of positioning the stent in the vessel and removing the cannula shaft so that the vessel is opened and expanded by the elastic stent. The other way includes steps of arranging a balloon inside the stent, placing the stent, introducing the catheter and the balloon in the vessel to a specific position by cardiac catheterization, blowing up the balloon to expand the specific site of the vessel, deflating the balloon and removing the balloon, and removing the catheter and the balloon. Since the stent moves in the vessel before arriving the blocked portion of the vessel, it is necessary for the stent to be smaller than the diameter of the vessel. Furthermore, when the stent is arrived at the blocked portion of the vessel, the vessel is expanded by the stent, so that the blood can smoothly flow through the vessel. In addition, since there are usually some other branch vessels near the blocked portion, most stents have a length ranged from 20 mm to 40 mm so as to facilitate the blood to flow in the branch vessels, and the non-opened stent has a diameter about of 1 mm so as to facilitate the stent to move in the vessel. The opened stent has a diameter ranged from 2 mm to 4 mm in response to the diameter of the vessel. For treating ascystic ducts, ureters, vas deferens or oviducts, the diameter of the stent can be up to 10 mm, and the length of the stent can be selected according to the specific treatment.

Nowadays, there are many methods for fabricating the stent. One method includes cutting the stainless and fusing the unnecessary portions to form braided stents by a laser with a high power, by laser. The foresaid conventional method is not easily operated since high precision 3D machine operation and positioning are needed in the method. The strength of the material would be decreased owing to the laser with high temperature in the cutting step, and the burr and the rough surface would be formed to block the blood flow and even to destroy blood cells or other compositions of the blood. Another method includes coating a photoresist on a metal tube by photolithography, developing, placing the metal in the etching solution and removing the portions uncovered by the photoresist. The drawback of the method is that the 3D tubular and braided stent cannot be integrally formed, and the rolling step is needed. It means that the metal is etched in a planar form, and moreover the portions covered by the mask would be immersed into the etching solution, so that the etching is not even and irregular, and it is hard to control the structure of the braided stent. The foresaid conventional methods are high cost. In Taiwan, the selling price of a stent is about 50,000 NTD. It is very expansive for a patient if plural stents are needed to be implanted in the patient.

Currently, there are no methods for fabricating a stent used for treating the blocked portion in intraluminal, so that the drug treatment is maintained to prevent restenosis after the stent is implanted into a patient, wherein the patient is treated with the oral drugs or the injectable drugs. However, the oral drugs are easily decomposed in the gastrointestinal tract, and the injectable drugs are easily adsorbed in the circulatory system, so that the drug amount on the blocked portion is extremely low. Therefore, it is necessary to increase the dosage of the drug. Accordingly, most of the drugs are wasted, and furthermore many side effects are occurred on the patient owing to taking too many drugs. In general, after being implanted with the stent, the patient has the restenosis, so that the patient should be followed to check the stent three to six months after being implanted with the stent. Therefore, it sould be very help if there is a stent coated with drugs for treating the blocked portion. Accordingly, the conventional drawbacks can be overcome and the selling price of the stent will be lowered if the fabricating method is performed with a cheap equipment.

### SUMMERY OF THE INVENTION

The object of the present invention is to provide a method for fabricating an implant stent with therapeutic effects. According to the prior application about fabricating vessel stents, the element analysis is used, the expanding conditions of the stent implanted in a body are studied, the stress on the line rib of the stent is studied, and a coating layer having anti-proliferation and anti-inflammation biodegradable material is coated on the stent in the present invention. The biodegradable material is slowly decomposed to release, so that the cell proliferation is inhibited on the treated portion to prevent from restenosis, and the therapeutic effects are achieved.

The present invention provides a method for fabricating stents with therapeutic effects. According to the present invention, the method includes designing and delineating the pattern of the implant stent, drilling a thin metal sheet for positioning, cutting a braided pattern of the stent according to the designed pattern, and drilling a hole on a line rib by a micro discharge processor, so that the semi-manufactured stent is a metal braided sheet with a row of holes on each line rib. Then, the braided metal sheet with a row of holes is rolled and soldered by micro-soldering to form a metal braided stent, and furthermore the stent is cleaned and polished by electropolish to trim the burr and the rough surface. Then, the biodegradable and absordable material, PLLA, PGA or a combination thereof, is resolved in a solution, wherein the anti-proliferation drugs, such as As₂O₅ or some anti-cancer drugs, are added. These anti-cancer drugs are grinded to particles with a micro or nano size. The solution with the biodegradable material and the anti-proliferation drugs or anti-inflammation drugs is completely evaporated and sprayed on the inner and outer surfaces of the stent. Since a row of holes are arranged on the line rib of the stent, each hole is immersed into the solution due to the capillary phenomenon. When the solution is completely evaporated, the biodegradable/absordable material and the drug are coagulated to form a solid and to strongly coat on the surface of the stent, so that the stent of the present invention is obtained.

### BRIEF DESCRIPTION OF THE DRAWINGS

The drawings disclose an illustrative embodiment of the present invention which serves to exemplify the various advantages and objects hereof, and are as follows:

FIG. 1 is a flow chart showing the method for fabricating an implant stent with therapeutic effects according to the present invention.

FIG. 2(a) is a planar view drawn by a computer to show the stent, wherein serial holes are drilled on the line rib.

FIG. 2(b) is a magnified view showing a part of FIG. 2(a), wherein serial holes are drilled on the line rib.

FIG. 3 is a schematic view showing a braided stent after being cut.

FIG. 4 is a magnified view showing the stent drilled by the micro precision discharge process.

FIG. 5(a) is a schematic view drawn by a computer to show the stent rolled into a tubular shape, wherein serial holes are drilled on the line rib.

FIG. 5(b) is a magnified view drawn by the computer to show the stent rolled into the tubular shape, wherein the serial holes are drilled on the line rib.

FIG. 5(c) is a schematic view showing the stent after being cut, wherein the stent has a braided structure with a diameter of 1.5 mm and a length of 16 mm.

FIG. 6 is a schematic view showing the stent having the sprayed biodegradable solution with drugs on the line rib of the stent, wherein the biodegradable material and the drugs are solidified on the stent, and the biodegradable material will slowly degrade from the surface of the stent to release the drugs.

FIG. 7 is a flow chart of compiling the program for analyzing the stress variations of the ANSYS vessel stent.

FIG. 8(a) is a schematic view drawn by the computer to show the stent, wherein the serial holes are etched on the line rib of the stent. When the stent is expanded at 7 atm, the stress and the stress variation distribution on the line rib are analyzed by the ANSYS method.

FIG. 8(b) is a schematic view drawn by the computer to show the stent, wherein the serial holes are etched on the line rib of the stent, The partial magnified view shows the stress and stress level analyzed by the ANSYS method when the stent is expanded at 7 atm.

FIG. 9 is a view showing the stent taken away from the sacrificed animal in the animal test last for one month, wherein the stent is implanted into the aorta of the rabbit. In FIG. 9, it is very clear that the endothelial cells are grown on the stent.

### DETAILED DESCRIPTION OF THE PREFERRED EMBODIMENT

### EXAMPLE I

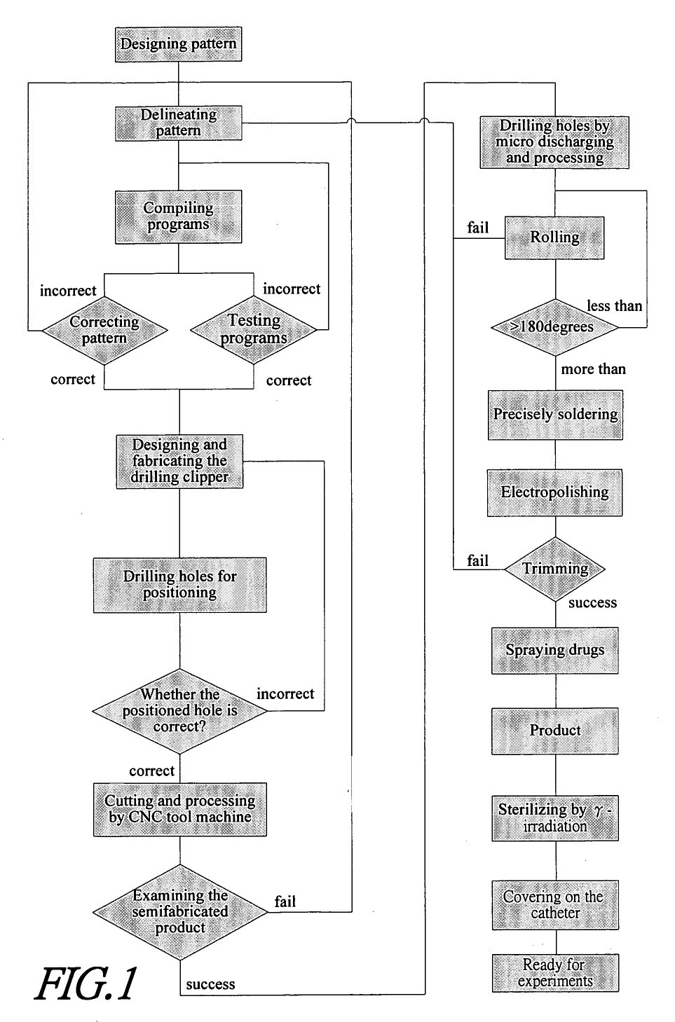

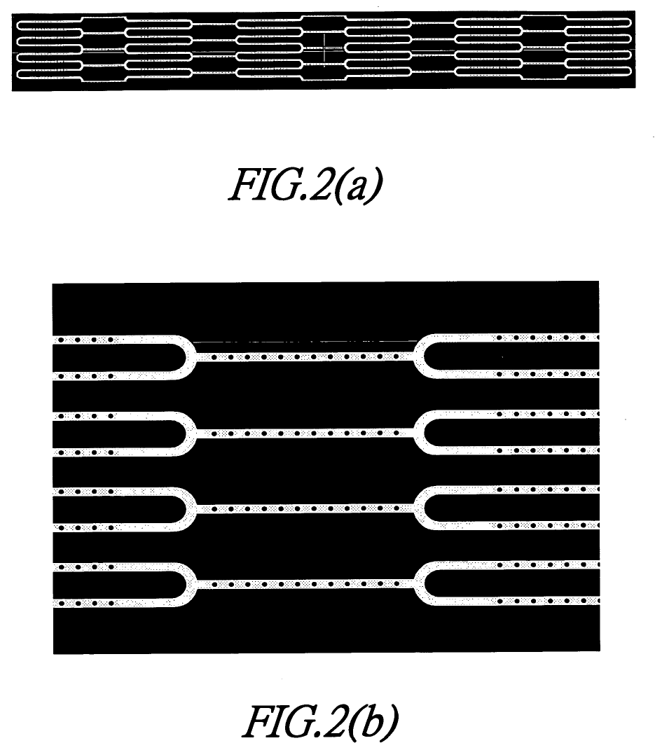

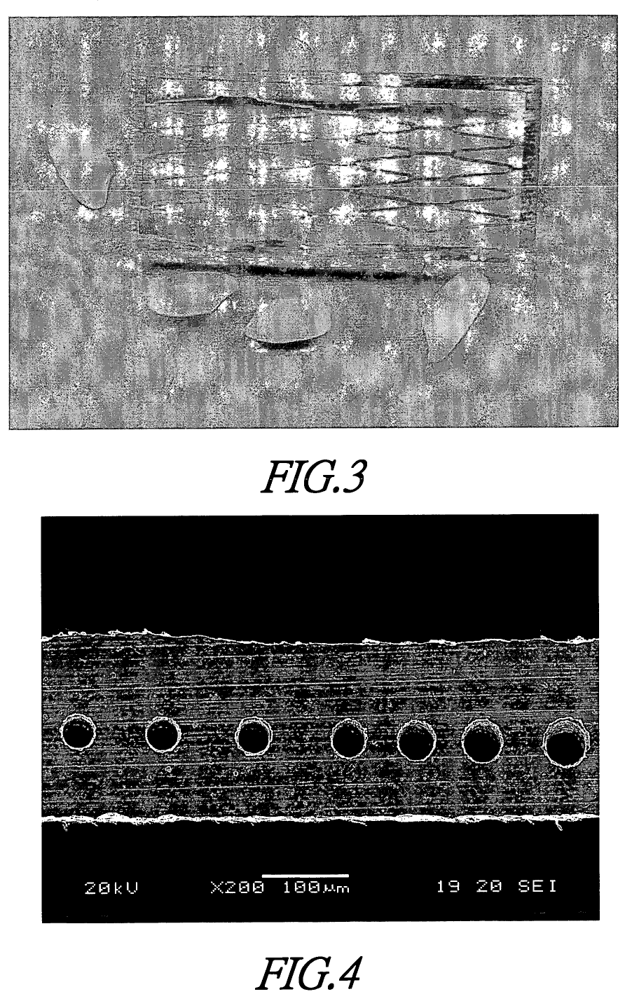

The present invention provides a method for fabricating a stent with therapeutic effects. FIG. 1 is a flow chart showing the method for fabricating the stent according to the present invention. Firstly, the pattern of the stent is designed and delineated by computer aided design (CAD), pro-engineering of software of solid-work to form the pattern as shown in FIGS. 2(a) and 2(b). Then, the program is complied and tested, wherein the program includes programs for subsequent drilling holes, cutting metal thin plate, controllable precision drilling and controllable cutting. The programs used in these tow machines have identical positioning portions to prevent from a sideways positioning. Then, the drill modules are designed and fabricated, wherein upper and lower steel plates respective having a thickness of 1 mm are used for clipping the metal thin plate to form a sandwich plate, and then to be drilled by the precision drilling machine. After positioning and drilling, it is necessary to examine the positions of the holes. If the positions are accurate, the stent is ready to be cut by the cutting machine, such as CNC machine. Accordingly, the obtained stent pattern is examined by the scanning electron microscopy, and thereby the image of the stent is shown in FIG. 3.

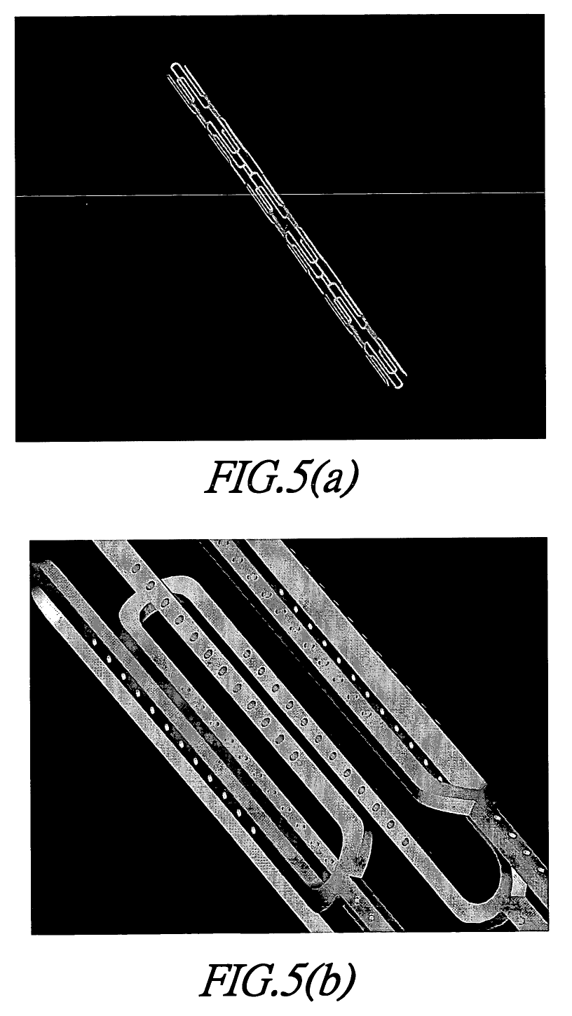

The stent are drilled to form serial holes on each line rib of the stent by the micro discharging process, wherein the diameter of the hole is one third of the width of the line rib of the stent. The diameter of the hole can be adjusted depending on the strength of the stent material. The shape of the hole is not limited, and the shape is a circle, a triangle or a tetragon. The distance between the two holes is about twice the diameter of the hole or several folds of the diameter of the hole. The magnified view of the part of the hole drilled by the micro discharging process is shown in FIG. 4.

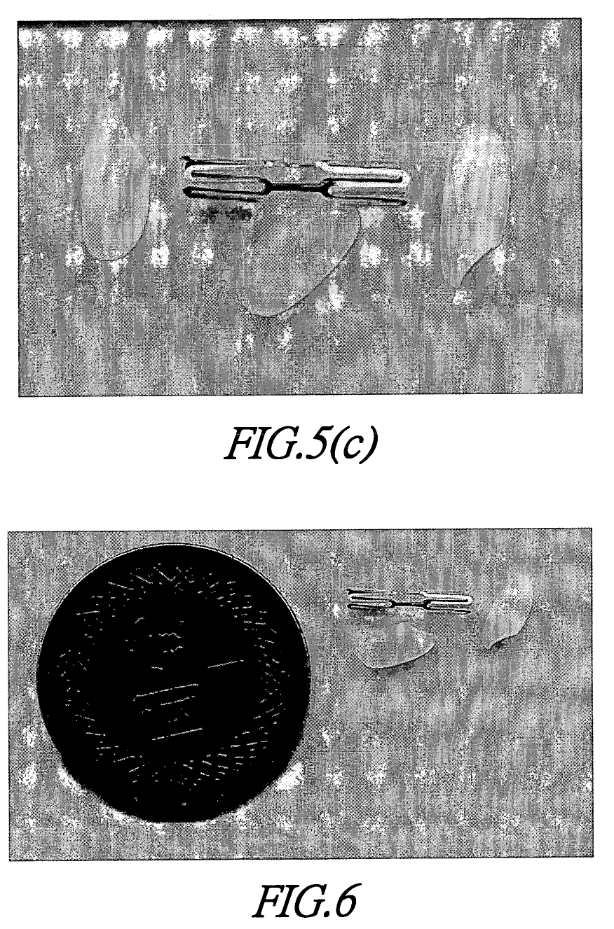

Then, the semi-manufactured stent is rolled and coated, wherein the planer metal braided structure is rolled to form a cylindric metal tube by the clipper, and further precisely micro coated. Then, the tubular stent is examined by the SEM. Please refer to FIGS. 5(a) to 5(c). The tubular stent is then cleaned and polished by electropolish to trim the burr and the rough surface. Consequently, the obtained stent is qualified by the SEM.

With regard to coating the drugs on the stent, the biodegradable materials including PLLA or PGA is solved in a solvent, such as acetone or chloroform, to form the solution, and then anti-proliferation drugs such as As₂O₅ or dexamethasone are added into the solution, wherein the drugs are grinded into the micro size, or even the nano size. The solution is blended, and then is atomized and sprayed on the outer and inner surfaces of the stent. When the solution is completely evaporated, the biodegradable/absordable material and the drug are coagulated to form a solid and to strongly coat on the surface of the stent as shown in FIG. 6. When the stent with the coated layer is implanted along with the catheter into a human body, the coated layer would not peer owing to the friction between the coated layer and the stent.

The PLLA layer formed on the surface of the stent has the biodegradable material such as dexamethasone or As₂O₅. The PLLA (C₃H₆O₃, C:H:O=40:6.71:53.29) has a molecular weight of 90.08 and the boiling point of PLLA is 392.2 K. The PLLA is transparent, and basically the PLLA is non-crystal or some crystal. The cystallinity of the PLLA is examined by X-ray. The solvent for the PLLA can be chloroform, acetone or the suspension solution having 1% w/w of PLLA and 2% w/w dexamethasone. The PLLA can have a low molecular weight about 80 kD or a high molecular weight about 320 kD. Then, the solution is sprayed on the stent, wherein the ratio of the dexamethasone to the PLLA is 2:1. For each stent, there are 0.8 mg of the dexamethasone and 0.4 mg of the PLLA, and the thickness of the coated layer is about 10 m. The chemical stability of the sprayed dexamethasone is analyzed by the chromatography spectra. In addition, the dexamethasone or As₂O₅ is also the drug with the nano size for killing cells. Before using the drug, the drug is examined by the TEM to check whether the drug has the nano size. When the fine drug powder is used on the stent with the biodegradable material, the drug slowly releases and the released drug is even distributed, so that the local concentration of the drug is not too high to stimulate the inner wall of the vessel and to induce the inflammation. The ratio of the material with a high molecular weight to the drug by weight is 1% or 2%. The grinded drug is examined by the EDS and X-ray to check the chemical composition and the crystallization of the drug.

The PLLA has no toxicity. For animals or human, there is little PLLA in the vessel and muscle, and the amount of the PLLA is increased after the extreme exercise. The PLLA is also present in the liver, the kidney, the thymus and the humoral flow. The PLLA is bioadsordable. CAS registration number is 79-33-4. The structural formula is shown as follows.

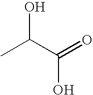

The PLLA has other names such as Lactic acid; L-(+)-Lactic acid; Propanoic acid, 2-hydroxy-, (S)-, Lactic acid, L-, Espiritin, (S)-2-Hydroxypropionic acid, (+)-Lactic acid, d-Lactic acid, L-Lactic acid, (S)-Lactic acid, (S)-(+)-Lactic acid, Paralactic acid, Propel, Sarcolactic acid, SY-83 and Tisulac.

Another biodegradable material, PGA (poly-glycolic acid), can be used alone or be used with the PLLA in the present invention. The PLLA and the PGA can be mixed in the proportions of 100-0%, 75-25%, 50-50%, 25-75% and 0-100%. These two biodegradable materials have different degradation velocities and biocompatibilities. They are used depending on the patient's need. The mixed biodegradable/biodegradable material is examined by x-ray to check the crystallization thereof before and after being coated on the stent. When the crystallinity of the drug is higher, the biocompatibility thereof is worse. Therefore, the preservation of the drug should be noted, and the drug should be stored at 2-8□ to avoid the crystallization of the drug. According to our experiment, the purchased drug is transparent, but turns to white after being agitated in the solution.

The formation of the second coating layer includes the step of dropping the fibrinogen and the thrombin solution on the stent. The fibrin is a natural material with the high molecular weight. The fibrin mass is coated on the whole stent, wherein the roughness of the fibrin mass surface depends on the pH of the solution and the ratio of the fibrin to the thrombin. The third coating layer has the forskolin and polyurethane, wherein the forskolin is the antiplatelet drug and the vasodilator. The fourth coating layer has the heparin mixed with the polyurethane-polyethylene oxide for being coated on the surface of the stent.

The coating layer is formed by spraying the material on the stent, the coated stent are dried, and thereby the stent with the drug-eluting polymer coating is obtained. Since parts of the drug are adsorbed by the non-injured positions in the body, the conventionally used dose for each of the above four drugs is more than the working dose, wherein the conventional used concentrations by weight for the above four drugs are 0.1%, 1%, 3% and 10%, respectively. Since the stent of the present invention has a coating layer thereon, the stent is sterilized by the ethylene oxide gas, assembled on the catheter, and then covered by the high molecular plastic cover to minimize the diameter of the stent. When the stent moves along with the catheter in the vessel to a specific position in the body, the plastic cover is pulled via the catheter, so that the stent is expanded due to the metal elasticity thereof. The drug coated on the stent slowly releases to facilitate the growth of the endothelial cells or to inhibit the thrombus or the restenosis. The principle of the slow-releasing drug is identical to that of the therapeutic pain-releasing patch.

Certainly, the drugs used in the present invention can be selected from a group consisting of angiogenic drugs, smooth muscle cell inhibitors, collagen inhibitors, vasodilators, anti-platelet substances, anti-thrombotic substances, anti-coagulants, cholesterol reducing agents and the combination thereof.

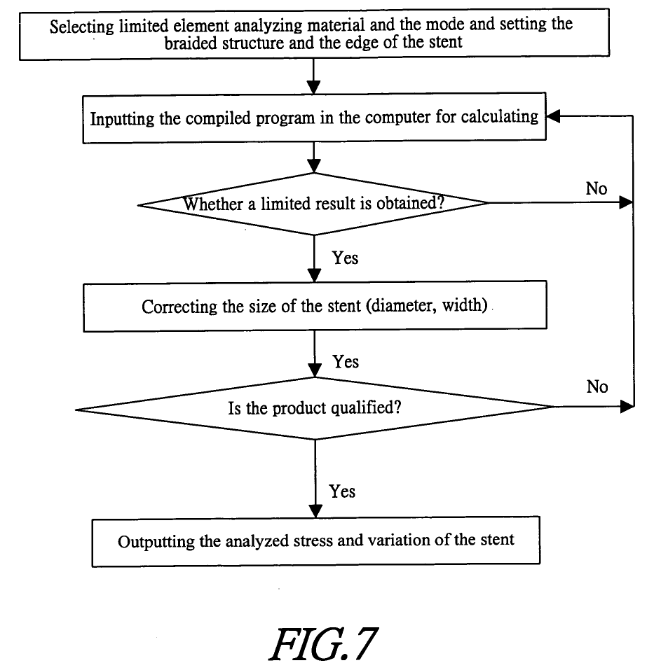

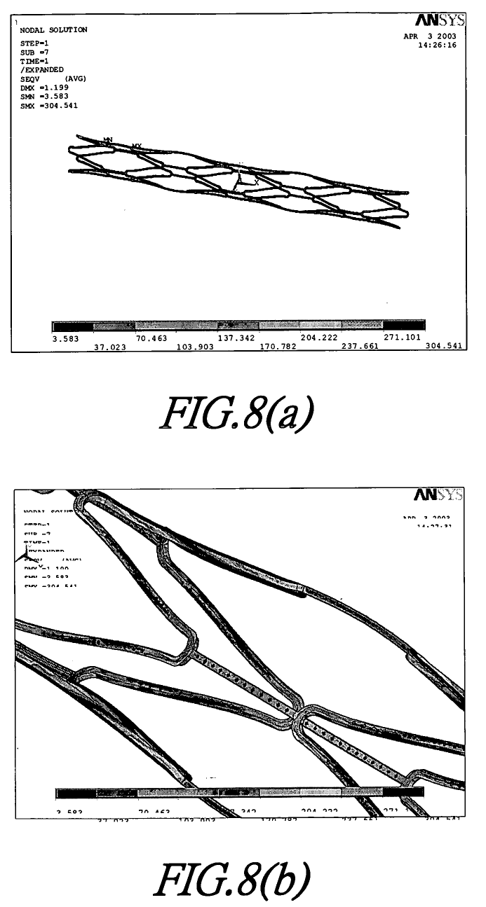

In order to prove that there is not too much stress on the line rib of the stent to break the stent via the holes on the line rib when the stent is expanded, the stent is examined and analyzed by the ANSYS software as shown in FIG. 7. It is proved by calculating the stress formed on the line rib when the stent is expanded that there is no significant stress variation on the stent line rib in different balloon angioplasties. Furthermore, the stress formed on the stent is not influenced, but the diameter of the stent is increased by the serial holes on the line rib of the stent as shown in FIGS. 8(a) and 8(b). Hence, after being coated with the drugs, the stress variation of the line rib of the stent is small, so that the coated layer would not peer during the balloon angioplasty. Therefore, the drugs can be delivered to the blocked portion in the body, and the drugs slowly release and the concentration of the released drug would not be too high. Accordingly, the stent of the present invention indeed has the therapeutic effects.

As the above descriptions, the present invention provides a vessel stent with the good property and the smooth edges. Furthermore, in contrast to the conventional method, the equipments used in the present invention are very mature technologies, so that the stent of the present invention is easily fabricated, and the cost of the stent is low.

### EXAMPLE II

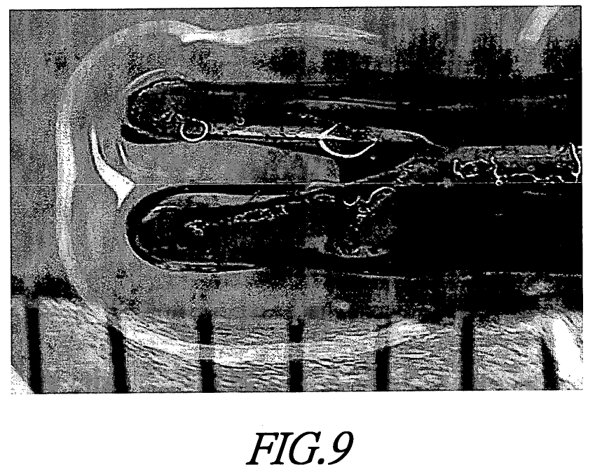

The biomedical component, the vessel stent, of the present invention is fabricated according to the Example 1, and the vessel stent is implanted into the aorta of the rabbit for one month. Then, the rabbit is sacrificed, and the vessel stent is taken away from the rabbit and is examined as shown in FIG. 9. Referring to FIG. 9, the stent is completely expanded. Hence, it is proved that the stent of the present invention is successfully applied in the animal and has the biocompatibility.

In conclusion, the method for fabricating the stent with the therapeutic effects is provided in the present invention, and the stent of the present invention can be easily fabricated and the cost is low. In addition, the quality of the stent provided by the present invention is good, and the edge and the surface of the stent are smooth. According to the present invention, the stent is well biocompatible, and the drug coated on the stent slowly releases to control the cell proliferation. Therefore, the restenosis is avoided. Since the present invention is never shown in the prior art, the present invention should be patented.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A method for fabricating an implant stent with therapeutic effects, comprising the steps of:
(a) designing and delineating a pattern of said implant stent;
(b) drilling a thin metal sheet to form positioning holes;
(c) cutting a desired pattern on said thin metal sheet according to said designed pattern;
(d) drilling a hole on a line rib of said stent to form a braided structure by a micro discharge processor according to said desired pattern;
(e) rolling and soldering said desired pattern to form a cylinder as a braided metal tube according to said braided structure, and trimming a burr and a rough surface of said braided metal tube by electropolish; and
(f) coating a biodegradable material mixed with a drug having a micro or nano size on an inner and an outer surfaces of said stent.

2. The method according to claim 1, wherein designing and delineating said pattern of said implant stent are performed by a computer software in said step (a).

3. The method according to claim 1, wherein drilling said positioning holes is performed by a program controllable precision driller in said step (b).

4. The method according to claim 1, cutting said thin metal sheet is performed by a program controllable cutting machine in said step (c).

5. The method according to claim 1, wherein said hole is formed by a program controllable micro discharge processor in said step (d).

6. The method according to claim 1, wherein said electropolish is performed the electrochemistry based electropolish technology in said step (e).

7. The method according to claim 1, wherein said drug having said micro or nano size has said therapeutic effects, and a coating agent is a biodegradable material.

8. A stent fabricated by said method for fabricating said implant stent with said therapeutic effects as claimed in claim 1.
